(19) United States
(12) Patent Application Publication
(10) Pub. No.: US 2023/0047945 A1
(43) Pub. Date: Feb. 16, 2023

(54) SYSTEM FOR MOUNTING ROOF TILES

(71) Applicant: Arka Energy Inc., Union City, CA (US)

(72) Inventors: MAHADEVA PRASAD H S, Chamarajanagar (IN); SUSHILKUMAR SENTHILNATHAN, Erode (IN)

(21) Appl. No.: 17/884,274

(22) Filed: Aug. 9, 2022

(30) Foreign Application Priority Data
Aug. 11, 2021 (IN) 202111036223

(51) Int. Cl. E04D 1/34; E04D 1/00

(52) U.S. Cl. CPC E04D 1/3402; E04D 1/2916; E04D 2001/3414; E04D 2001/3444

(57) ABSTRACT

A roof tile mounting system is disclosed, having a plurality of T-shaped metal footings each configured for detachable fixing of one tile through a snap fit locking mechanism. The mounting blocks are attached to a deck arranged in rows parallel to deck ridge. Each metal footing includes male and female features for side-to-side and row-to-row alignment of the metal footings when being fixed on the roof deck. This makes the process of tile mounting easy and less time consuming. The metal footings further include extended arm for tile support, rail guides for mounting guidance and misalignment prevention, and pad mounting provision for water ingress to a successive tile. The tiles include guide springs that engage with the snap fit locking mechanism for detachable mounting and push back springs to provide push back force during mounting.

### CROSS-REFERENCE TO RELATED APPLICATIONS

This application claims priority to India Application No. 202111036223, filed Aug. 11, 2021, the disclosure of which is incorporated herein by reference.

### TECHNICAL FIELD

The present disclosure relates generally to a tile mounting system. In particular, it relates to a system for installing solar tiles on roof tops.

### BACKGROUND

Background description includes information that may be useful in understanding the present invention. It is not an admission that any of the information provided herein is prior art or relevant to the presently claimed invention, or that any publication specifically or implicitly referenced is prior art.

Conventional systems of installing solar panels on residential roof tops generally involves using elevated steel structures or sections that show a Photovoltaic system as a separate entity and not part of the roof. The module size, shape and colour may not match with that of the roof and this generally leads to poor aesthetics. In order to improve aesthetics, the modules need be installed as part of the roof and should look similar to the roof tiles, shingles, and the like.

Furthermore, in conventional systems for solar tiles mounting, it is difficult to replace individual panels and other modules which are generally arranged in a grid type assembly. Prior-art systems may use snap fitting or snap locking mechanism for attaching tiles; however, such systems provide less flexibility for installing and/or removing tiles.

Therefore, there is a need to provide an aesthetically designed solar power system in which modules can be installed as part of the roof and which can obviate aforementioned limitations in the art.

### OBJECTS OF THE INVENTION

A general object of the present disclosure is to provide a system for mounting tiles, such as solar tiles, which obviates the above mentioned limitations of conventional tile mounting systems.

An object of the present disclosure is to mount solar tiles or shingles on a roof deck in an aesthetic manner.

An object of the present disclosure is to provide a tile mounting system which is structurally stable to provide protection from external conditions such as wind, rain, snow, and the like.

Another object of the present disclosure is to provide a tile mounting system that allows servicing of the tiles by removing the tiles from the roof.

Another object of the present disclosure is to provide a tile mounting system that makes the process of tile mounting easy and faster.

Another object of the present disclosure is to provide a solar tile mounting system having improved fire rating for facilitating fire prevention.

Another object of the present disclosure is to provide a tile mounting system that requires fewer parts and results in cost saving.

### SUMMARY

Aspects of the present disclosure relate to a system for mounting of tiles at a roof deck. In an aspect, the proposed system for mounting tiles is based on a metal footing that is fixed to the roof deck, and is configured to detachably support one tile. The metal footings can be fixed on the roof deck in rows parallel to a deck ridge of the roof deck and thereafter the tiles can be detachably mounted on the fixed metal footings In particular, the metal footing includes features that enable alignment between adjacent metal footings as well as rows of the metal footing, thereby easing the process of fixing them of the roof deck.

In an embodiment, the metal footings are T-shaped having a horizontal portion and a vertical portion. The vertical portion extends perpendicular to the horizontal portion from a substantial mid-point of the horizontal portion. The plurality of metal footings are fixed to the roof deck in rows such that the horizontal portion is parallel to a deck ridge of the roof, and a free end of the vertical portion engages with the horizontal portion of one of the metal footing in the adjacent row.

Each of the metal footing supports one tile with a side of the tile supported on the horizontal portion and the vertical portion supporting a middle portion of the tile.

The metal footings can be fixed to the roof deck by screws such that the free end of the vertical portion of the metal footings is proximal to the deck ridge.

The metal footings can include a tile middle support located on the vertical portion to support the middle portion of the tile.

The metal footings can have snap fit locking clips located on the horizontal portion. The locking clips can be configured to engage with corresponding guide springs provided on a back side of the tiles to enable detachably mounting of the tiles with the metal footings.

The system can further include a metal strip fixed to at least one side of the tiles. The guide springs can be fixed to the metal strip.

The system can also include push back springs located on the metal strips of the tiles. The push back springs can provide a push back force to the tiles to detachably mount the tiles to the metal footings.

One end of the horizontal portion of the metal footings can include a male feature and the opposite end of the horizontal portion can have corresponding female feature. When the metal footings are fixed on the roof deck, the mate and female features of the horizontal portions of the adjacent metal footings in a row can engage with each other. This can ensure side to side alignment of the metal footings without any markings and measurements, and accordingly side by side alignment of the tiles to be removably fixed to the metal footings.

A free end of the vertical portion of the metal footings can include a male row to row reference feature that can engage with a corresponding feature on adjacently located ends of the horizontal portions of the adjacent metal footings in the adjacent row. This engagement can provide a row-to-row reference to the metal footings, and thereby row to row reference to the tiles to be removably fixed to the metal footings.

The metal footings can have a pair of guide rails for guiding the corresponding tile for mounting and preventing misalignment of the tile during mounting.

The metal footings can include a pad mounting provision for enabling fluid ingress from the tiles to the tiles in the adjacent row.

The system can include a plurality of longitudinal pads located parallel to the vertical portion of the metal footing at junction of the adjacent metal footings in the rows. Distal end of the longitudinal pads can engage to the metal footing through hooks provided at the distal end of the longitudinal pads. There can be corresponding holes in the metal footing for engaging the hooks. The proximal end of the longitudinal pads can rest on the metal footing of the adjacent row on the proximal side.

The longitudinal pads can have channel shaped cross section for drainage of water from the tiles mounted thereon. The tiles can be mounted on the adjacent metal footings such that there is a gap between them, and water from the adjacent tiles is drained to the channel shaped longitudinal pads through the gap between the tiles and from there to the proximal side row of the metal footings.

One or more surfaces of the metal footings can be covered with gaskets to avoid direct contact with the corresponding tile.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIGS. 1A and 1B illustrate diagrammatic representations of an integrated metal footing of the proposed tile mounting system, in accordance with embodiments of the present disclosure.

FIGS. 2A and 2B illustrate diagrammatic representations of a tile of the proposed system, in accordance with embodiments of the present disclosure.

FIG. 3A illustrates a diagrammatic representation of the proposed system after mounting of the tiles, in accordance with embodiments of the present disclosure.

FIGS. 4A-4C illustrate an arrangement of tiles mounted on integrated metal footings with support for water ingress, in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Embodiments explained herein relate to a tile mounting system. More specifically, it relates to a system for installing solar roof tiles on roof tops.

In an embodiment, the proposed tile mounting system may be designed to install one or more solar roof tiles, that may be similar in appearance to roof tiles or shingles, to a roof deck in a very easy manner while maintaining normal properties of a roof such as protecting the house from environmental conditions such as wind, rain, snow, and/or other conditions. The proposed tile mounting system may be configured to create arrangements for solar roof tile assembling and/or dismantling. The tile mounting system may be easy maintainable, support easy cable routing or management, take less time for tile installation, water proof, and/or fire retardant.

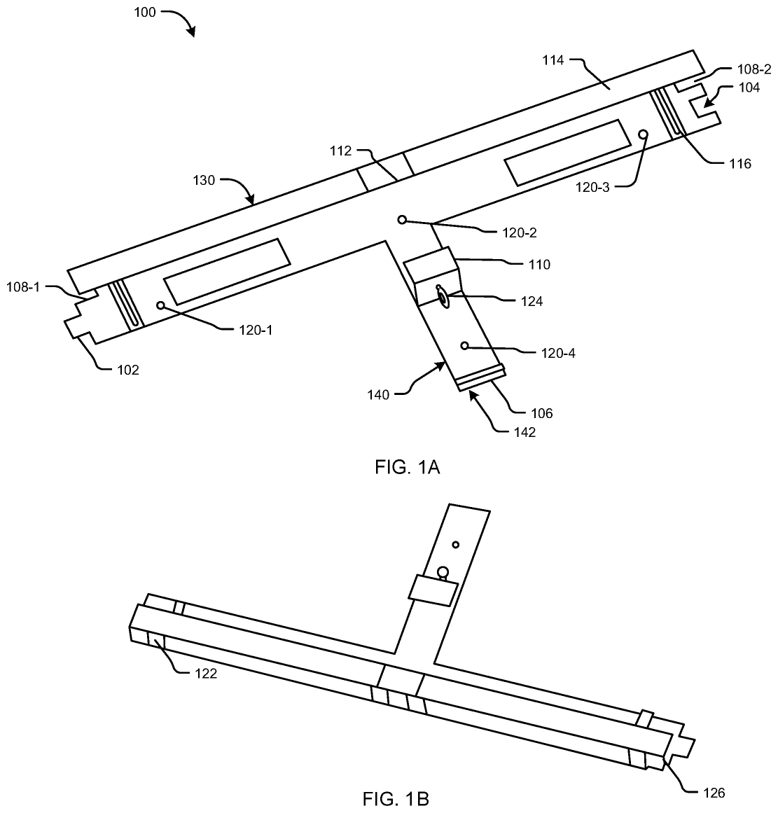

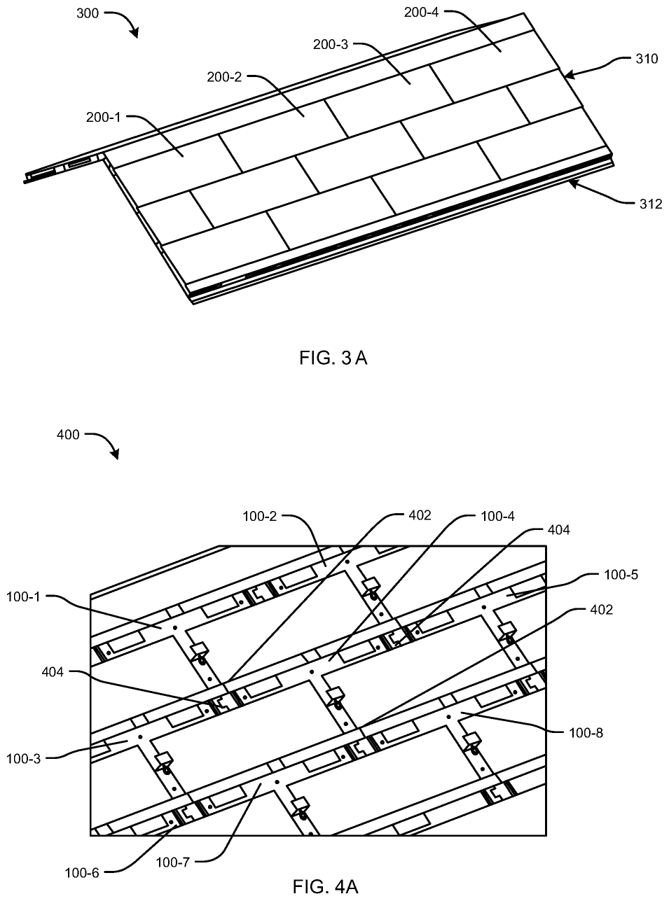

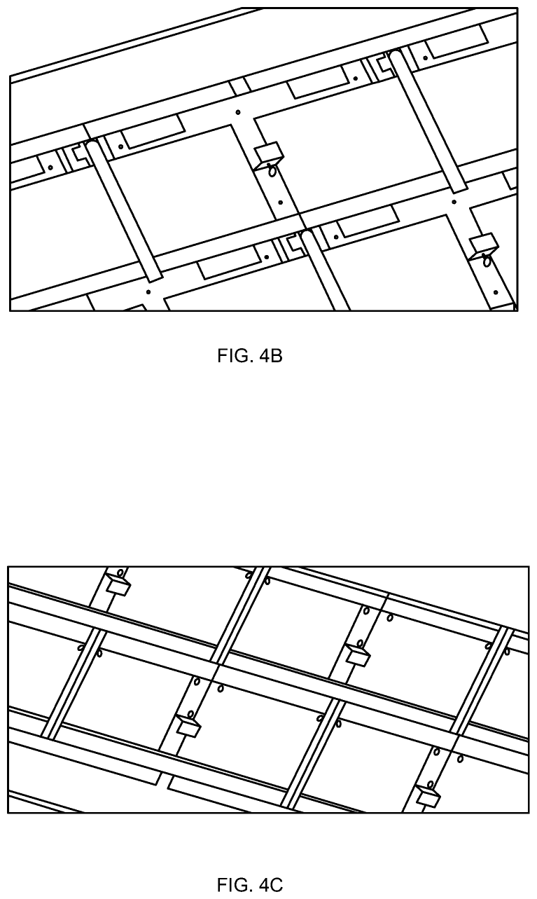

Referring to FIGS. 1A and 1B where exemplary views of a metal footing 100 of the disclosed system for mounting tiles on a roof deck is disclosed, the integrated metal footing 100 can be T-shaped having a horizontal portion 130 and a vertical portion 140. The vertical portion 140 can extend perpendicular to the horizontal portion 130 from a substantial mid-point of the horizontal portion 130, as in case of the capital alphabet T. The plurality of metal footings 100 can be fixed to the roof deck in rows, as shown in FIGS. 4A to 4C, such that the horizontal portion 130 is parallel to a deck ridge 312 of the roof 310 (refer to FIG. 3). A free end 142 of the vertical portion 140 can engage with the horizontal portion 130 of one of the metal footing 100 in the adjacent row.

In an embodiment, the metal footings 100 can be fixed to the roof deck 310 by hardware, such as but not limited to threaded screws, such that the free end 142 of the vertical portion 140 of the metal footings 100 is proximal to the deck ridge 310. The metal footings 100 can includes holes, such as holes 120-1, 120-2. 120-3, . . . etc. (Collectively referred to as holes 120), for fixing on the roof deck with hardware.

In an embodiment, the metal footing 100 is configured to supports one tile with a side of the tile supported on the horizontal portion 130 and the vertical portion 140 supporting a middle portion of the tile. For supporting the middle portion of the tile, the metal footings 100 can include a tile middle support 110 located on the vertical portion 140. When the tile mounted on the metal footing is a solar tile, the metal footing 100 can include one or more hooks 124 located on the tile middle support 110 for routing of wire or cable.

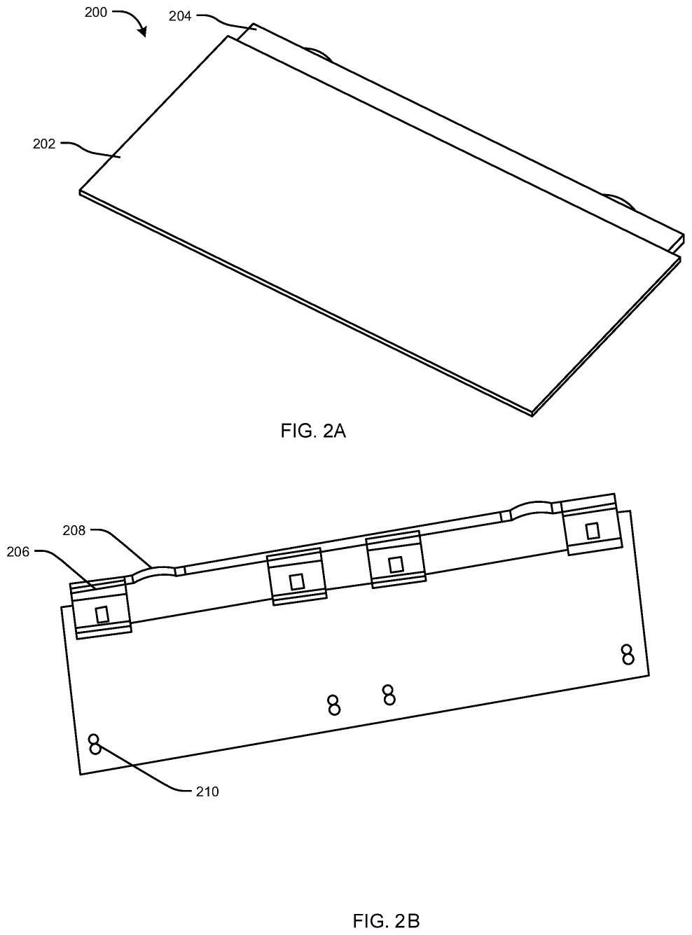

To facilitate detachable fitting of tiles on the metal footings, the metal footings 100 can have snap fit locking clips 122 located on the horizontal portion 130. The locking clips 122 can be configured to engage with corresponding guide springs 206 (refer to FIG. 2) provided on a back side of the tiles to enable detachably mounting of the tiles with the metal footings 100.

In an embodiment, in order to facilitate side by side alignment of the metal footings 100, and thereby alignment of the tiles mounted thereon, in a row, one end of the horizontal portion 130 of the metal footings 100 can include a male feature 102 and the opposite end of the horizontal portion 130 can have corresponding female feature 104. When rows of the metal footings 100 are being fixed on the roof deck, the metal footings 100 can be placed side by side in the desired orientation and the male feature 102 can be engaged with the female feature of the adjacent metal footing 100. This can ensure side to side alignment of the metal footings 100 without any markings and measurements. Thereafter, when the tiles are detachably fixed on the metal footings 100, side by side alignment of the tiles shall also be ensured.

In an embodiment, in order to facilitate row to row alignment of the metal footings 100 and the tiles, the free end 142 of the vertical portion 140 of the metal footings 100 can include a male row to row reference feature 106. The male row to row reference feature 106 can be configured to engage with a corresponding female feature, such as the female features 108-1 and 108-2 on the two ends of the metal footings, which, when the adjacent mate footings 100 of the adjacent row are placed side by side, form a single female feature 108 for the male feature 106 to engage with. This engagement, along with the length of the vertical portion 140, can provide a row-to-row reference to the metal footings 100 without having to do any measurements and markings. Subsequently, when the tiles are detachably fixed to the metal footings 100 row to row alignment of the tiles is also achieved.

The metal footings 100 can further include a pair of guide rails 116-1 and 116-2 (collectively guide rail 116) for guiding the corresponding tile for mounting and preventing misalignment of the tile during mounting.

The metal footings can include a pad mounting provision 112 for enabling fluid ingress from the tiles to the tiles in the adjacent row.

One or more surfaces of the metal footings can be covered with gaskets, such as gasket 114, to avoid direct contact with the corresponding tile.

Further, the metal footing 100 may include a plurality of grooves 118-1 and 118-2 for water drainage. Additionally, one or more pad hanging provisions 126 may also be inbuilt in the metal footings 100.

FIGS. 2A and 2B shows a tile assembly configured to be removably/detachably filled to the metal footings 100 of the proposed system for mounting of tiles.

In an embodiment, the proposed tile assembly 200 may include a top metal strip 204 which may be attached to the tile using structural adhesive(s) and/or adhesive tapes. Alternatively, the strip 204 may be embedded or fastened with the tile 200. The metal strip 204 may be intended to provide additional stiffness to tile assembly and avoid spring to glass contact. Tile 200 may have a glass and/or material body 202. The tile assembly 200 may include a plurality of guide springs 206-1, 206-2, 206-3, and 206-4. The plurality of guide springs 206 may be configured to guide the tile 200 onto the metal footings 100 and avoid misalignment during assembly. Further, the tile 200 may also include one or more push back springs 208-1 and 208-2. The one or more push back springs 208 may be attached on a top side of the metal strip 204. The one or more push back springs 208 may be configured to provide push back force to the tile 200 and ensure positive snap fit locking with metal footings 100.

FIG. 3A illustrates a diagrammatic representation of the proposed system after mounting of the tiles 200, in accordance with embodiments of the present disclosure.

As illustrated, in the proposed tile mounting system 300, a plurality of tiles 200-1, 200-2, 200-3, etc. are mounted on a roof deck 302 in rows parallel to the deck ridge 312 using a plurality of metal footings 100-1. 100-2, 100-3, . . . etc. that are fixed to the roof deck 310 side by side and in rows, as shown in FIG. 4A, using the side-by-side and row-to-row alignment features as described earlier.

In an embodiment, as shown in FIG. 4B and FIG. 4C, the system for mounting tiles can include a plurality of longitudinal pads, such as longitudinal pads 406-1 and 406-2 (hereinafter collectively referred to as longitudinal pads 406) located parallel to the vertical portion 140 of the metal footing 100. The longitudinal pads 406 can be located at junction of the adjacent metal footings in the rows. Distal end (with reference to the deck ridge 312) of the longitudinal pads 406 can engage to the metal footing 100 through hooks provided at the distal end of the longitudinal pads 406. There can be corresponding holes in the metal footing 100 for engaging the hooks. The proximal end of the longitudinal pads 406 can rest on the metal footing 100 of the adjacent row on the proximal side.

The longitudinal pads 406 can have channel shaped cross section for drainage of water from the tiles 200 mounted thereon. The tiles 200 can be mounted on the adjacent metal footings 100 such that there is a gap between them, and water from the adjacent tiles 200 is drained to the channel shaped longitudinal pads 406 through the gap between the tiles 200 and from there to the proximal side row of the metal footings 100.

In another embodiment, the proposed system may facilitate a solar tile to be directly mounted on the roof deck with integrated metal footings 100 for making mounting of the tiles easy and fast. The system may also allow easy maintenance and servicing of one or more tiles by allowing removal of the one or more tiles from any part of the roof deck. The proposed system may be structurally stable to withstand snow load and wind-up lift load. The Proposed system may be configured to provide aesthetic and good looking solar roof top.

In another embodiment, the proposed system may be easy to install because of fewer parts used in the system. The system may be configured to take less time for installation, thereby having lower cost of installation. The system may be configured to improve performance of photovoltaic system due to an elevated deck structure. The system may include a plurality of vents to facilitate convective cooling at rear side of the tiles. The system may ensure good aesthetics and take care of roof undulations. The system may be configured to provide better cable routing and power device attachment. The system may have improved fire rating as one or more system components may be made of suitable fire retardant materials and elevated from the roof deck. The system may be configured to support easy dismantling process.

In yet another embodiment, the proposed system may incorporate the use of tile assemblies and a set of metal footings to couple the tile assemblies with a roof deck. The tile assembly may include one or more tiles such as photovoltaic (PV) tiles, Non-PV tiles, glass tiles and the like. A metal strip may be adhered to at least one side of the tile, where the metal strip may be configured to provide stiffness to the tiles and facilitate in protecting the tiles from direct contact to one or more fastening components. A set of guide springs may be attached on one or more pre-defined positions on the metal strip to assist in alignment of one tile at the time during tile mounting. A set of push back strings may be attached with the metal strip to facilitate in snap fit locking of the tile with the footing.

In still another embodiment, the footing may be designed in a T-shape structure. The footing may have a first part and a second part, where both ends of the first part may be designed such that a first end of a second footing may be locked with a second end of the first footing, and a bottom end of the second part may be designed to be locked with a top side of the first end of each footing. Additionally, the footing may include a gasket which may be positioned on top side of the first part that may facilitate in protecting the tile to be in direct contact with the footing. A set of guide rails on the footing may that facilitate in attaching the tiles. A set of snap fit locking clips of the footing may be designed to lock with a tile. A protrusion of the footing may provide support to the attached tile. A pad arrangement may be provided to facilitate water ingress from one tile to a successive tile. Further, the footing may include grooves to drain water from roof deck, and a set of bended clips to assist in managing cable or wire.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

### Advantages of the Invention

The present disclosure provides a system for mounting tiles, such as solar tiles, which obviates the above mentioned limitations of conventional tile mounting systems.

The present disclosure provides a system for mounting tiles that enables mounting of solar tiles or shingles on a roof deck in an aesthetic manner.

The present disclosure provides a tile mounting system which is structurally stable to provide protection from external conditions such as wind, rain, snow, and the like.

The present disclosure provides a tile mounting system that allows servicing of the tiles by removing the tiles from the roof.

The present disclosure provides a tile mounting system that makes the process of tile mounting easy and faster.

The present disclosure provides a solar tile mounting system having improved fire rating for facilitating fire prevention.

The present disclosure provides a tile mounting system that requires fewer parts and results in cost saving.

1. A system for mounting tiles on a roof deck, the system comprising:
a plurality of metal footings configured to be fixed to the roof deck, wherein each of the plurality of metal footings is T-shaped having a horizontal portion and a vertical portion extending perpendicular to the horizontal portion from a substantial mid-point of the horizontal portion;
wherein the plurality of metal footings is fixed to the roof deck in rows wherein the horizontal portion is parallel to a deck ridge of the roof, and a free end of the vertical portion engages with the horizontal portion of one of the plurality of metal footings in an adjacent row;
wherein each of the plurality of metal footing supports a tile with a side of the tile supported on the horizontal portion and the vertical portion supporting a middle portion of the tile.

2. The system as claimed in claim 1, wherein the plurality of metal footings is fixed to the roof deck by screws wherein the free end of the vertical portion of the plurality of metal footings is proximal to the deck ridge.

3. The system as claimed in claim 1, wherein the plurality of metal footings comprises a tile middle support located on the vertical portion to support the middle portion of the tile.

4. The system as claimed in claim 1, wherein the plurality of metal footings comprises snap fit flocking clips located on the horizontal portion, wherein the snap fit flocking clips are configured to engage with corresponding guide springs provided on a back side of the tile to enable detachably mounting of the tile with the plurality of metal footings.

5. The system as claimed in claim 4, wherein the system comprises a metal strip fixed to at least one side of the tile, and wherein the guide springs are fixed to the metal strip.

6. The system as claimed in claim 5, wherein the system comprises push back springs located on the metal strip, wherein the metal strip is configured to provide push back force to the tile to detachably mount the tile to the plurality of metal footings.

7. The system as claimed in claim 1, wherein two ends of the horizontal portions of the plurality of metal footings comprise male and female features, the male and female features configured to enable engagement between the male and female features of an adjacent plurality of metal footings in the rows to ensure side to side alignment of the plurality of metal footings and side by side alignment of the tile removably fixed to the plurality of metal footings.

8. The system as claimed in claim 1, wherein a free end of the vertical portion includes a male row to row reference feature that engages with a corresponding feature on adjacently located ends of the horizontal portions of an adjacent plurality of metal footings in an adjacent row to provide a row-to-row reference to the metal footings, and thereby row to row reference to the tile to be removably fixed to the plurality of metal footings.

9. The system as claimed in claim 1, wherein each of the plurality of metal footing comprises a pair of guide rails for guiding the corresponding tile for mounting and preventing misalignment of the tile during mounting.

10. The system as claimed in claim 1, wherein each of the plurality of metal footing comprises a pad mounting provision for enabling fluid ingress from the tile to the tile in the adjacent row.

11. The system as claimed in claim 1, wherein the system comprises a plurality of longitudinal pads located parallel to the vertical portion of the plurality of metal footing at a junction of an adjacent plurality of metal footings in the rows, wherein a distal end of the longitudinal pads is engaged to the plurality of metal footing through hooks provided at the distal end of the longitudinal pads that engage with corresponding holes in the plurality of metal footings, and wherein the proximal end of the longitudinal pads rests on the plurality of metal footings of an adjacent row on the proximal side.

12. The system as claimed in claim 11, wherein the plurality of longitudinal pads has a channel shaped cross section for drainage of water from the tile mounted thereon with gap there between, and wherein water from an adjacent tile is drained to the proximal side row of the plurality of metal footings.

13. The system as claimed in claim 1, wherein one or more surfaces of the plurality of metal footings is covered with one or more gaskets to avoid direct contact with the corresponding tile.
